(19) United States
(12) Patent Application Publication
(10) Pub. No.: US 2002/0133414 A1
(43) Pub. Date: Sep. 19, 2002

(54) Mediated shopping method and system

(76) Inventors: Salil Vjaykumar Pradhan, Santa Clara, CA (US); Wei-Ying Ma, Fremont, CA (US); Rajiv Bansal, Champaign, IL (US)

Correspondence Address: HEWLETT-PACKARD COMPANY, Intellectual Property Administration, P.O. Box 272400, Fort Collins, CO, 80527-2400, US

(21) Appl. No.: 09/809,150

(22) Filed: Mar. 14, 2001

(51) Int. Cl. G06F 17/60

(52) U.S. Cl. 705/26

(57) ABSTRACT

A method and system for mediated shopping. First, a client requests product information from a merchant or seller's web site through a mediator. Second, the mediator receives the requested information from the merchant, adapts the information into a format compatible with the client, and then provides the adapted information to the client. Third, the client sends the mediator requests to add or delete items from a shopping cart. In response to these requests, the mediator updates the shopping cart record. Fourth, the client sends the mediator a purchase request to purchase one or more items in the shopping cart. In response to the purchase request, the mediator updates the shopping cart record to reflect the purchase. The mediator also provided mediated payment services and delivery services so that customer information (e.g., credit card number and delivery address) is not revealed to the merchant.

### FIELD OF THE INVENTION

The present invention relates generally to electronic commerce transacted across a network, such as the Internet, and more particularly, to a mediated shopping method and system.

### BACKGROUND OF THE INVENTION

Shopping for merchandise is a favorite past time for some, but is a needed activity for all. Since we live in a society that is very specialized, there is always the need for certain products or services that are vital to our lives. We are familiar with physical shopping, where a customer enters a store. The merchandise is displayed on shelves or on the floor in the store. The customer selects one or more products and pays for the purchases at a check-out counter. Physical shopping allows the customer to “touch and see” the tangible products. However, physical shopping can be time consuming, especially if the consumer is engaged in comparison shopping. For example, a consumer can easily spend hours in driving to different stores across town to compare prices of a desired product.

In recent years, with the advent and growth of electronic commerce on the Internet, there has been an increase in on-line shopping. In this type of shopping, a customer logs onto a web site of a product manufacturer or distributor, selects one or more products being offered on-line, electronically pays for the products, and receives delivery of the products at some future time. One advantage of on-line shopping over physical shopping is that on-line shopping allows a consumer to perform comparison shopping with minimal effort in a time efficient manner and in the comfort of the consumer's home.

However, it is noted that one significant disadvantage of on-line shopping as compared to physical shopping is that the customer is unable to “touch and see” the product. Typically, the customer is limited to reading a description or seeing a picture of the product. The products are “intangible” in this regard until the customer takes delivery of the product. As can be appreciated, often times the quality and suitability of the merchandise are difficult to ascertain through pictures and written description.

Accordingly, it would be desirable for there to be a mechanism that can merge physical shopping and on-line shopping so that the customer is provided with a pervasive shopping experience (i.e., a shopping experience that does not end at the physical boundaries of the physical store and that does not end at the end of an electronic commerce transaction).

Furthermore, there are several disadvantages or problems with the current shopping models. First, from the customer's perspective, the customer may not want to divulge sensitive information, such as credit card numbers, etc. to one or more vendors. Unfortunately, on-line transactions require that the customer provide such information to the vendor for payment.

Second, from the merchant's perspective, the merchant desires to determine whether the customer on the other side of the transaction is genuine and reliable. The current shopping model does not allow for determining the reliability of the customer besides identification (e.g., valid driver's license) and reliable payment (e.g., cash or valid credit card number or account).

Third, as the number of different types of devices and the number of different communication protocols increase, there is an increased burden on the merchant or seller to develop and maintain product information that can be suitably displayed or otherwise compatible with these various different standards and protocols. This task becomes even more daunting in that there are new types of devices and new communication protocols that are constantly being developed and released into the market place.

Based on the foregoing, there remains a need for a method and system for a mediated shopping method and system to provide a pervasive shopping experience that overcomes the disadvantages set forth previously.

### SUMMARY OF THE INVENTION

According to one embodiment of the present invention, a method and system for a mediated shopping are provided. First, a client requests product information from a merchant or seller's web site through a mediator. Second, the mediator receives the requested information from the merchant, adapts the information into a format compatible with the client, and then provides the adapted information to the client. Third, the client sends the mediator requests to add or delete items from a shopping cart. In response to these requests, the mediator updates the shopping cart record. Fourth, the client sends the mediator a purchase request to purchase one or more items in the shopping cart. In response to the purchase request, the mediator updates the shopping cart record to reflect the purchase. The mediator also provided mediated payment services and delivery services so that customer information (e.g., credit card number and delivery address) is not revealed to the merchant.

In one embodiment, the mediator includes shopping cart and payment services integrated therein.

In this manner, the mediator handles payment and delivery of the product so that customer information (e.g., credit card number and delivery address) is not revealed to the merchant. The merchant is provided assurance regarding the genuineness of the customer since the customer has a trusted relationship with the mediator.

According to another embodiment of the mediated shopping method and system of the present invention, certain shopping cart related services are performed by a separate dedicated server or service. In this embodiment, requests received by the mediator are simply re-directed and passed to the appropriate server or service. For example, add and remove requests can be passed to a shopping cart server that in turn processes the add requests and remove requests. Similarly, purchase requests can be passed to a payment server that in turn processes the purchase requests.

### BRIEF DESCRIPTION OF THE DRAWINGS

The present invention is illustrated by way of example, and not by way of limitation, in the figures of the accompanying drawings and in which like reference numerals refer to similar elements.

FIG. 1 is a block diagram of a mediated shopping system according to one embodiment of the present invention.

FIG. 2 illustrates sources or uniform resource locators (URLs) in accordance with a third embodiment of the present invention.

FIG. 3 is a block diagram that illustrates in greater detail the mediator of FIG. 1 in accordance with one embodiment of the present invention.

FIG. 4 illustrates a mediator that is implemented with an HTTP proxy in accordance with one embodiment of the present invention.

FIG. 5 illustrates a mediator that is implemented with a WAP gateway in accordance with another embodiment of the present invention.

FIG. 6 is a block diagram that illustrates in greater detail the shopping services of FIG. 1 in accordance with one embodiment of the present invention.

FIG. 7 is a flow chart illustrating the processing steps performed by the shopping system of FIG. 1 in accordance with one embodiment of the present invention.

### DETAILED DESCRIPTION OF THE PREFERRED EMBODIMENT

A method and system for mediated shopping are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Mediated Shopping System 100

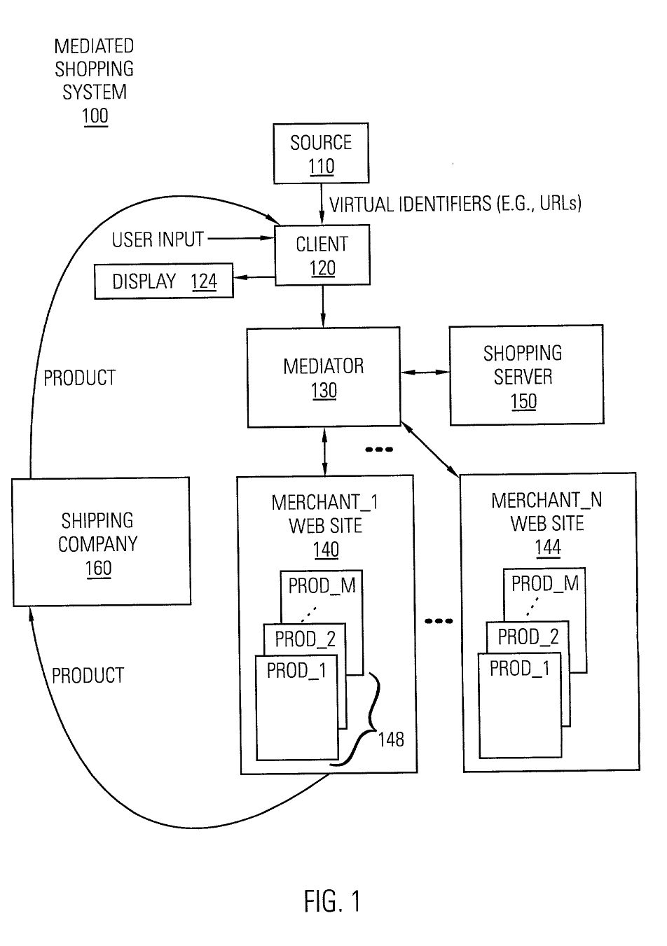

FIG. 1 is a block diagram of a mediated shopping system 100 according to one embodiment of the present invention. The mediated shopping system 100 includes a source 110 of virtual identifiers that provides virtual identifiers (e.g., uniform resource identifiers (URIs) and uniform resource locators (URLs)) associated with products or services of interest. A virtual identifier is typically a short string of characters (e.g., a name or address) that refer to resources.

In contrast to a physical identifier (e.g., a physical price tag or brochure for a product), a virtual identifier is intangible (e.g., stored electronically or requiring electronic means to interpret).

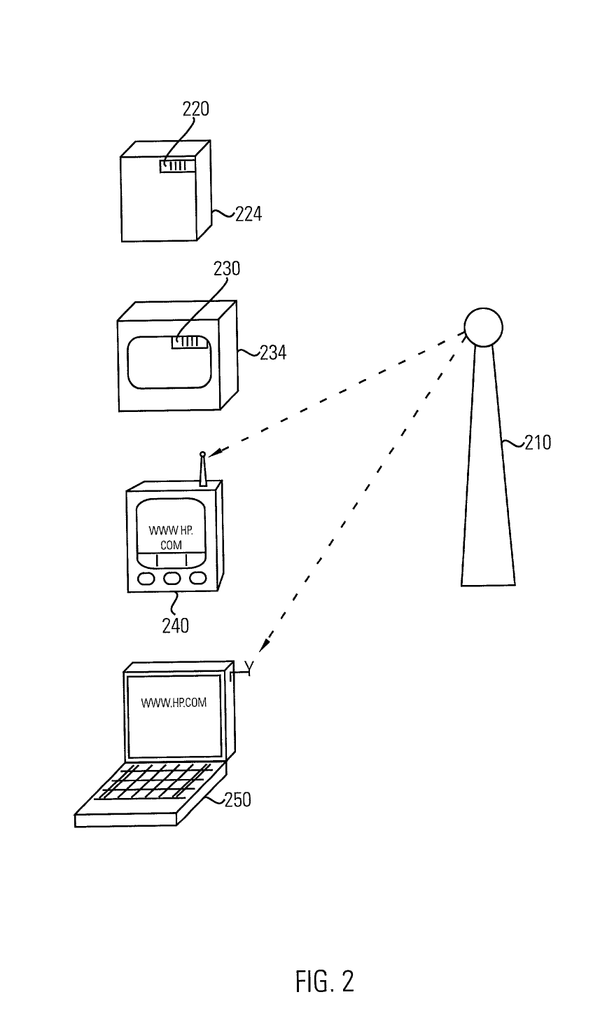

A URL can, for example, specify a web page that describes product information (e.g., information regarding a product or service that a buyer may need to decide whether to purchase the product). The source 110 transmits or broadcasts URLs in a vicinity of the source 110. Alternatively, the URLs can be in the form of a readable code that can be located, affixed, or otherwise associated with the product or merchandise. Some examples of sources 110 of virtual identifiers are described in greater detail hereinafter with reference to FIG. 2.

The system 100 also includes one or more clients 120 for use by a user to purchase products and services. The client 120 includes a combination of hardware and software that provides access to a network (e.g., the Internet) across which the shopping transaction is being processed. The client 120 further includes a combination of hardware and software for 1) selectively generating add requests to place products into a shopping cart in response to user input (e.g., activating an ADD button in the browser program); 2) selectively generating remove requests to remove items from a shopping cart in response to user input (e.g., activating an REMOVE button in the browser program); 3) generating purchase requests to purchase items in the shopping cart in response to user input (e.g., activating a BUY button in the browser program); and 4) displaying information to the user. The displayed information can include information related to the contents of the shopping cart, items that have been purchased, and product information. The information is displayed on a display (e.g., a display 124) that requires information to be in a particular format (e.g., HTML format or VML format) for display.

For example, the client 120 can be, but is not limited to, a portable computer that has facilities (e.g., a modem and Internet Service Provider (ISP)) to connect to the Internet, a cellular telephone with facilities to connect to the Internet, a personal digital assistant (PDA) or other device that has access to the Internet.

For example, the client 120 can communicate by employing a wireless access protocol (WAP), which is referred to as a WAP client. The WAP client can be, for example, a cellular telephone. The client 120 can also communicate by employing an HTTP protocol, which is referred to as an HTTP client. The HTTP client can be, for example, a portable laptop computer, personal digital assistant (PDA), or any other device that communicates by utilizing the HTTP protocol. It is noted that there may be many different types of clients 120. The same type of clients 120 may communicate with the network by employing different communication protocols.

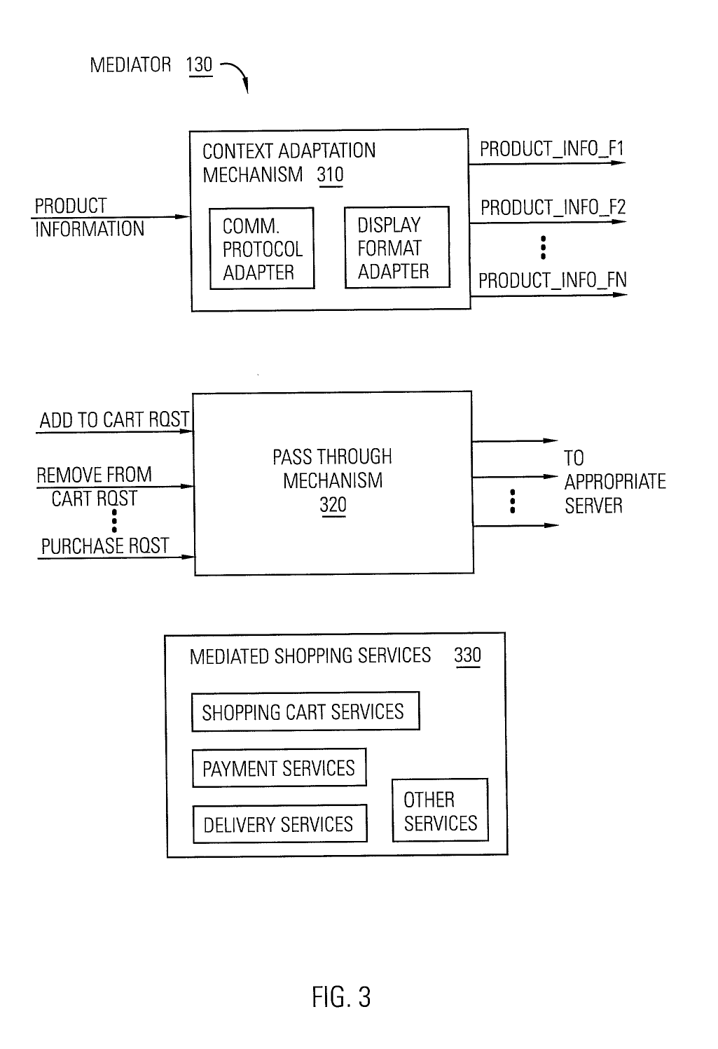

The system 100 also includes a mediator 130 for providing mediated shopping services for the client 120. These mediated shopping services can include, but is not limited to, communication protocol conversion, content adaptation, shopping cart services, and payment services, and delivery services. The mediator 130 is described in greater detail hereinafter with reference to FIG. 3.

One aspect of the present invention provides the mediator 130 to adapt the content (e.g., product information and specification) provided by the merchant into an appropriate format that is understandable by the client 120. For example, the mediator 130 adapts the content into a format that is displayable on the client 120 and communicates the adapted information through a communication protocol that is suitable for the client 120.

The system 100 includes a plurality of web sites (e.g., Merchant_1's web site 140 and Merchant_N's web site 144) where each web site can correspond to a particular merchant or seller (M1, M2, . . . , M_N). Each web site can have a plurality of web pages (e.g. web pages 148). For example, there may be a web page dedicated for each product or service (e.g., PROD_1, PROD_2, . . . , PROD_M) that is being offered by the merchant.

One advantage of the mediated shopping system of present invention is that the mediator 130 1) dynamically adapts information provided by a merchant to a format that is displayable by the client, and 2) communicates the information to the client by employing a communication protocol that is utilized by the client, thereby reducing the burden on the merchant or the seller to perform these time-consuming and costly tasks. The merchant can, for example, simply provide to the mediator 130 product information in a generic form (e.g., in text or ASCII format), which is readily available from a database file or other storage without having to re-format the information or concern itself with how to effectively communicate with the client 120.

The web site 140 includes information about the product and how to purchase the product. The product information can include, for example, the product specifications (e.g., product features, electrical specifications, mechanical specifications, etc.), price, availability, promotion specials, etc.

The system 100 also includes a shopping server 150 for maintaining the shopping cart and client account information. Furthermore, the shopping server 150 can, for example, have accounts with various different sellers and merchants.

It is noted that the mediator 130 can be integrated with a shopping server 150 and include shopping services. Alternatively, the mediator 130 can be implemented alone and separate from other services (e.g., shopping server). In this alternative embodiment, the mediator 130 simply re-directs requests for shopping services (e.g., payment and delivery) and other services to a dedicated server responsible for the particular task or service.

The system 100 can also include a shipping company 160 for providing delivery services to deliver the product from the seller to the buyer or customer.

Sources of Virtual Identifiers

FIG. 2 illustrates examples of sources 110 of virtual identifiers (e.g., universal resource locators (URLs)) in accordance with a third embodiment of the present invention. The sources 110 can, for example, a beacon 210, a scannable code 220 that is affixed to a document 224 (e.g., product literature, price tag, marketing brochure, or other magazine), an electronic code 230 that is retrievable and stored in an electronic device 234 (e.g., a television, a computer system, etc.).

There are two primary ways to access virtual identifiers (URLs) of products or services of interest. The first way is through passive reception. In this case, when devices (e.g., personal digital assistant 240 and portable lap top computer 250) are within a predetermined range of a beacon 210 the devices receive the URLs. The second way is through active interrogation. In this case, the device scans a readable code on a product or queries another electronic device for a URL. The readable code can be, for example, scannable codes in magazines, written codes in text form, or codes displayed on device screen (e.g., a TV).

Mediator 130

FIG. 3 is a block diagram that illustrates in greater detail the mediator 130 of FIG. 1 in accordance with one embodiment of the present invention. The mediator 130 includes a content adaptation mechanism 310 for receiving information in a generic form (e.g., ASCII text) and converting the information into a format suitable for the client 120 (e.g., into a format that can be used and displayed by the client 120) and packaging the information for communication into a communication protocol that is compatible to the client 120. For example, the mediator 130 receives product information (e.g., price and product specifications) and converts the product information into N different types of formats (e.g., seller-information_F1, seller-information_F2, seller-information_F3, . . . , seller-information_FN) that are suitable for the respective N devices.

The mediator 130 includes a pass-through mechanism 320 for receiving information and requests and in response thereto for providing the information as is to another server. It is noted that certain requests or other information do not require any changes. In this case, the information passes directed through the mediator 130 without modification or adaptation. As described in greater detail hereinafter, requests for certain mediated services may be re-directed or passed directly to a corresponding server.

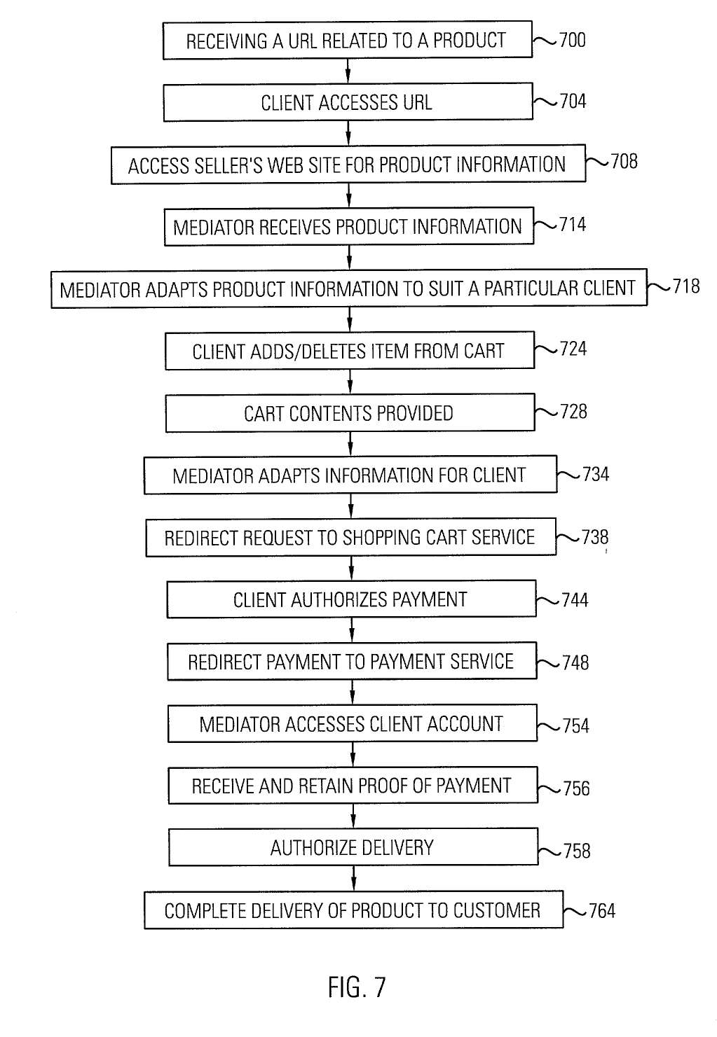

The mediator 130 also can include mediated shopping services 330 (e.g., adding and deleting items from shopping cart, payment processing, delivery, etc.). The mediated shopping services 330 are described in greater detail with reference to FIG. 7.

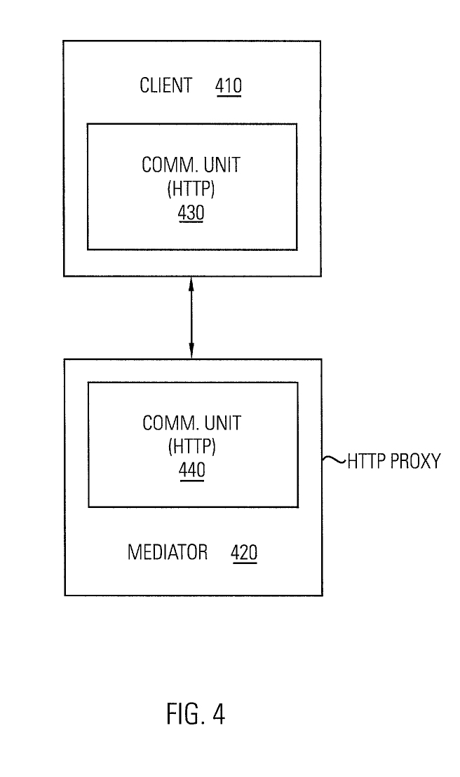

FIG. 4 illustrates a mediator that is implemented with an HTTP proxy in accordance with one embodiment of the present invention. In this embodiment, the system 400 includes a client 410 and a mediator 420. The client 410 includes a communication unit 430 for communicating information through an HTTP protocol. In addition, the client 410 displays content and information in an HTML format. The mediator 420 includes a communication unit 440 for communicating information with the client 410 by employing the HTTP protocol. The mediator 420 can be implemented as an HTTP proxy for providing the content adaptation function and the other mediated shopping services.

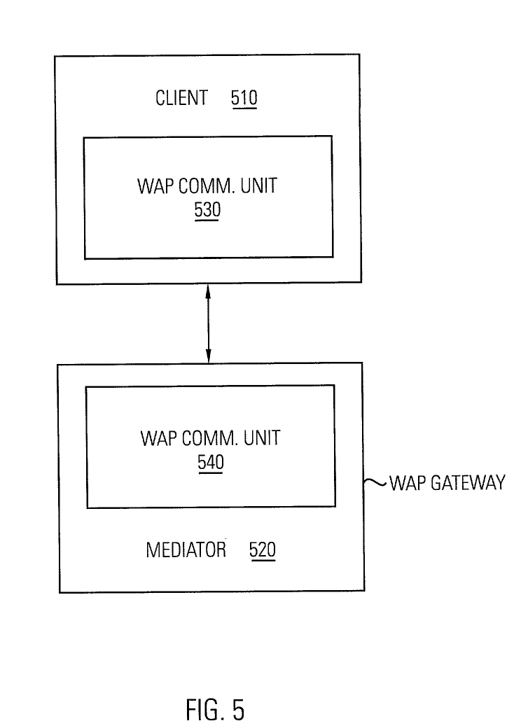

FIG. 5 illustrates a mediator that is implemented with a WAP gateway in accordance with another embodiment of the present invention. In this embodiment, the system 500 includes a client 510 and a mediator 520. The client 510 includes a communication unit 530 for communicating information through a wireless application protocol (WAP) protocol. In addition, the client 510 displays content and information in a VML format. The mediator 520 includes a communication unit 540 for communicating information with the client 510 by employing the WAP protocol. The mediator 520 can be implemented as a WAP gateway for providing the content adaptation function and the other mediated shopping services.

Mediated Shopping Services

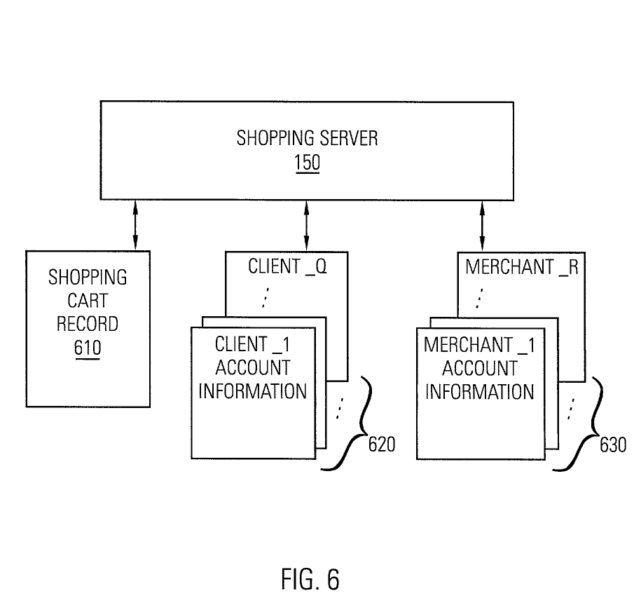

FIG. 6 is a block diagram that illustrates in greater detail the shopping server 150 of FIG. 1 in accordance with one embodiment of the present invention.

The Shopping Cart Engine

The shopping server 150 can include a group of services (or some other server-side mechanism) that handles received requests and generates corresponding responses. The server 150 can include a persistent record 610 of the current contents of a shopping cart. For example, the record 610 can be a database, file or any other persistent system. The server 150 can also include a plurality of client accounts 620, where each client account has information related to that client. For example, each client account may include profile information such as credit card number, client preferences, and billing address. The server 150 also includes a plurality of merchant accounts 630, where each merchant account has information related to that seller or merchant.

The shopping server 150 performs the following steps. In response to a request from the client 120, the shopping server 150 updates the persistent shopping cart record 610 to reflect the addition/deletion of an item to the shopping cart. The shopping server 150 also provides the mediator 130 with the current contents of the shopping cart for adaptation and transmission to the client 120. The shopping server 150 also updates the shopping cart contents to reflect bought or purchased items. The shopping server 150 also obtains the URLs of the web sites from which the purchases are made in order to complete the purchasing transaction on behalf of the user.

The shopping server 150 then employs the account information 630 of the sellers of the items of interest to complete the purchases. The shopping server 150 updates the client account information with the proofs of purchase, and the shipping company is given the authorization to deliver items to the consumer.

FIG. 7 is a flow chart illustrating the processing steps performed by the shopping system of FIG. 1 in accordance with one embodiment of the present invention. The mediator of the present invention provides the following services: 1) mediated product information retrieval with dynamic content adaptation; 2) mediated shopping services (e.g., adding and deleting items from a universal shopping cart that can be used for both physical shopping and on-line shopping); 3) mediated payment services; and 4) mediated delivery or shipping services.

Mediated Product Information Retrieval Processing

In step 700, a URL related to a product of interest is received from a URL source. In step 704, the client accesses a URL corresponding to an item of interest. In step 708, a seller's web presence is accessed for the item-related information. In step 714, the information about the item is passed to the mediator. In step 718, the mediator adapts the information to suit, for example, a specific device type and communication protocol and then passes the adapted information to the client.

Mediated Addition or Deletion of Products Processing

In step 724, the client authorizes addition/deletion of the item to/from the shopping cart. In step 728, the current shopping cart contents are sent from the cart. In step 734, the mediator adapts the information (e.g., shopping cart contents) to suit, for example, a specific device type and communication protocol and then passes the adapted information (e.g., shopping cart contents) to the client current for display. In step 738, the client's request is redirected to the shopping cart services that adds the item to or deletes the item from the shopping cart.

Mediated Payment Processing

In step 744, the client authorizes payment for the items in current shopping cart. In step 748, the client request is redirected to the payments service. For example, in one embodiment, the mediator may debit the customer's account and transfer funds or payment to the merchant. In step 754, the mediator accesses its accounts in various payment servers to make the payment for bought items. In step 756, proof of payment received from the merchant and retained.

Mediated Delivery Processing

In step 758, authorization is given to shipping company to pick up packet(s) of bought items from seller(s) and deliver them to the client. In step 764, delivery of the product is completed to client.

Anonymous Shopping

In an alternative embodiment, a shopping system is provided for users or customers, who desire to shop anonymously. A customer has a computing device, such as a personal digital assistant (PDA) that is equipped with a web address receiving program (e.g., E-squirt program) for receiving URLs related to products or other goods. These URLs, for example, can be transmitted by a beacon that is disposed adjacent to or near the associated merchandise.

The customer can then employ a web browser program to receive the web address and to use the web address to request product information by employing the mediator of the present invention.

A mediator allows a user to establish an account therewith for shopping. The mediator can also provide a universal shopping cart for use in both physical shopping and on-line shopping. The mediator can also provide the ability to gather information regarding products of interest from an on-line source by physically being present in a store and noting products of interest (e.g., by collecting URLs of products of interest while walking around in a physical store).

The mediator also provides mediated shopping services, payment services, and shipping services. Consequently, the mediator can provide private shopping services by not disclosing a user's account information (e.g., credit card number or shipping address) to the merchant. In fact, a customer's private information remains private by employing the mediator of the present invention. It is noted that the merchants are given added assurance that the customer is legitimate and credit-worthy since there is an existing relationship between the customer and the mediator.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A method for providing mediated services to a client device having a predetermined communication protocol and a predetermined display format comprising:
(a) receiving a request for a web page from the client device;
(b) sending the request to a merchant web site;
(c) receiving the requested information from the merchant web site;
(d) transforming the information into the predetermined communication protocol and predetermined display format that is suitable for the client device; and
(e) sending the transformed information to the client device.

2. The method of claim 1 further comprising:
(f) providing at least one mediated electronic commerce service for a merchant.

3. The method of claim 2 wherein the step of providing at least one electronic commerce service for the merchant includes one of shopping cart services, billing services, shipping services, and payment services.

4. The method of claim 1 wherein the step of transforming the information into the predetermined communication protocol and predetermined display format that is suitable for the client device includes:
transforming the information into one of an HTTP communication protocol and WAP communication protocol.

5. The method of claim 1 wherein the step of transforming the information into the predetermined communication protocol and predetermined display format that is suitable for the client device includes:
transforming the information into one of a HTML display format and VML display format.

6. The method of claim 1 wherein the step of receiving the requested information from the merchant web site includes:
receiving information in one of a proprietary format, a mark-up language format, an XML format, and other format designed for exchanging information.

7. The method of claim 1 further comprising:
(f) providing mediated shopping services; wherein the step of providing mediated shopping services includes
the client device sending a request to add or delete items from a shopping cart; and
receiving the add or delete requests, and responsive thereto for updating a shopping cart record.

8. The method of claim 1 further comprising:
(f) providing mediated payment services; wherein the step of providing mediated payment services includes
the client sending a purchase request to purchase one or more items in a shopping cart;
receiving the purchase request; and
responsive to the purchase request for updating a shopping cart record to reflect the purchase.

9. The method of claim 8 wherein the step of providing mediated payment services further includes a client providing payment information to a mediator;
the mediator debiting a client's account; and
the mediator handling payment to a merchant;
wherein the account information of the client is not provided to the merchant.

10. The method of claim 1 further comprising:
(f) providing mediated shipping services; wherein the step of providing mediated shipping services includes
the client sending delivery information to a mediator;
the mediator directly providing the delivery information to a shipping company and arranging for the shipping company to pick-up the merchandise from the merchant;
wherein the client delivery information is not provided to the merchant.

11. A system comprising:
(a) a merchant that sells one or more products, the merchant providing information in a predetermined format concerning at least one product; and
(b) a mediator configured to communicate with the merchant for receiving the product information in the predetermined format and for transforming the product information into a plurality of communication protocols and display formats so that devices having different communication protocols and display formats can process the product information.

12. The system of claim 11 further comprising:
a first electronic commerce service provider for providing an electronic commerce service to the merchant.

13. The system of claim 11 wherein the first electronic commerce service provider is one of a shopping cart service provider, a billing service provider, a payment service provider, a shipping service provider, and a content adaptation service provider.

14. The system of claim 11 wherein the mediator includes
a content adaptation mechanism for automatically transforming the information into one of an HTTP communication protocol and WAP communication protocol.

15. The system of claim 11 wherein the mediator includes
a content adaptation mechanism for automatically transforming the information into one of a HTML display format and VML display format.

16. The system of claim 11 wherein the mediator receives the product information in one of a proprietary format, a mark-up language format, an XML format, and any other format designed for exchanging information.

17. The system of claim 11 wherein the mediator further comprises:
a mediated shopping service provider for receiving add or delete requests from a client, and responsive thereto for updating a shopping cart record.

18. The system of claim 11 wherein the mediator further comprises:
a mediated payment service provider for receiving a purchase request from a client, and responsive to the purchase request for updating a shopping cart record to reflect the purchase.

19. The system of claim 18 wherein the mediated payment service provider receives payment information from the client, and responsive thereto, arranges for payment of the merchandise with the merchant without disclosing client payment information to the merchant.

20. The system of claim 11 wherein the mediator further comprises:
a mediated shipping service provider for receiving delivery information from a client, and responsive thereto for directly providing the delivery information to a shipping company, thereby arranging for delivery of the merchandise from the merchant to the client without disclosing client delivery information to the merchant.
